(19) United States
(12) Patent Application Publication
(10) Pub. No.: US 2024/0430781 A1
(43) Pub. Date: Dec. 26, 2024

(54) METHODS AND APPARATUSES FOR ENABLING WIRELESS TRANSMIT/RECEIVE UNIT (WTRU)-BASED EDGE COMPUTING SCALING

(71) Applicant: InterDigital Patent Holdings, Inc., Wilmington, DE (US)

(72) Inventors: Michel Roy, Candiac (CA); Kevin Di Lallo, Laval (CA); Ulises Olvera-Hernandez, Saint-Lazare (CA); Robert Gazda, Spring City, PA (US)

(73) Assignee: InterDigital Patent Holdings, Inc., Wilmington, DE (US)

(21) Appl. No.: 18/707,563

(22) PCT Filed: Nov. 7, 2022
(86) PCT No.: PCT/US2022/079371

§ 371 Date: May 3, 2024

Related U.S. Application Data
(60) Provisional application No. 63/277,391, filed on Nov. 9, 2021.

(51) Int. Cl. H04W 48/08; H04L 67/10; H04L 67/289; H04W 48/18

(52) U.S. Cl. CPC H04W 48/08; H04L 67/10; H04L 67/289; H04W 48/18

(57) ABSTRACT

Methods and apparatuses are described herein for wireless transmit/receive unit (WTRU)-based edge compute autoscaling. For example, a WTRU may receive a message from a network device. The message may include a list of one or more edge application servers (EAS) associated with an un-instantiated application. The WTRU may select an EAS from the list of one or more EAS associated with the un-instantiated application. The WTRU may transmit a request to an edge data network (EDN), the request indicating a request to instantiate the un-instantiated application at the selected EAS. The WTRU may receive a response from the EDN, the response indicating that the un-instantiated application has been instantiated at the selected edge application server and indicating information for accessing the now instantiated application at the EAS.

### CROSS-REFERENCE TO RELATED APPLICATION

This patent application claims the benefit of U.S. Provisional Patent Application No. 63/277,391, filed on Nov. 9, 2021, the entirety of which is herein incorporated by reference.

### BACKGROUND

Self-Organizing Network (SON) is a concept defined as automation technology designed to make planning, configuration, management, optimization, and healing of mobile radio access network simpler and faster. SON concepts also exist in cloud computing; a key aspect of cloud compute self-organization is called autoscaling. Autoscaling is a method for dynamically adjusting the number of servers in a group, using the computational load of that group. The objective is to allow cloud applications to scale as usage increases. Cloud scaling techniques typically rely on key performance indicators (KPIs) measured at the servers and KPI provided by load balancers steering the incoming traffic to these servers. Autoscaling is coarse-grained and typically reactively applied to demand. This technique is well suited for datacenter environments where compute is co-located and abundant. As edge computing becomes ubiquitous and compute moves close to mobile terminals, scaling edge network resources needs to evolve. However, cloud computing autoscaling is not appropriate for handling edge fine-grained, limited, and distributed compute. Thus, methods and apparatuses that enable autoscaling for mobile edge computing are needed.

### SUMMARY

Methods and apparatuses are described herein for wireless transmit/receive unit (WTRU)-based edge compute autoscaling. For example, a WTRU may transmit, to an edge data network (EDN), an edge application server (EAS) discovery request that includes one or more EAS requirements. The WTRU may receive, from the EDN, an EAS discovery response that includes a list of executing EAS and on-demand EAS, e.g. an EAS that is not executing. The WTRU may transmit, to the EDN, based on a selection of an on-demand EAS from the list of executing EAS and on-demand EAS, an on-demand EAS instantiation request indicating the selected on-demand EAS. The WTRU may receive, from the EDN, an on-demand EAS instantiation response indicating an EAS instantiation synchronously or asynchronously. On a condition that the EAS instantiation is indicated synchronously, the on-demand EAS instantiation response may include EAS information associated with the selected on-demand EAS. On a condition that the EAS instantiation is indicated asynchronously, the on-demand EAS instantiation response may include a result code indicating a status of the EAS instantiation and the WTRU may receive, from the EDN, an on-demand EAS instantiation notification that includes EAS information associated with the selected on-demand EAS. The WTRU may transmit, based on the EAS information, data to the selected on-demand EAS.

A method implemented by the WTRU may include receiving a message from a network device. The message may provide a list of one or more EAS identifiers. Each EAS identifier may be associated with an un-instantiated application. The method may include selecting one or more EAS identifiers from the list of EAS identifiers associated with un-instantiated applications. The method may include transmitting a message to an EDN. The message may provide indicating a request to instantiate one or more un-instantiated applications at the EDN. The method may include receiving a response from the EDN. The response may include indicating that the un-instantiated application has been instantiated at the selected EDN and including information for accessing the newly instantiated application instance at the EDN.

The method may include transmitting an EAS discovery request to the EDN. The EAS discovery request includes indicating one or more EAS requirements. The method may provide sending a message provides an EAS discovery response received in response to the EAS discovery request.

The method may include comprising a list of one or more EAS identifiers associated with an already instantiated version of the instantiated application.

The method may provide for sending information for accessing the newly instantiated application. This information may indicate whether the newly instantiated application has been synchronously or asynchronously instantiated.

The method may provide for sending information for accessing the newly instantiated application that indicates that the newly instantiated application has been synchronously instantiated. The method may provide for sending information that the EAS instantiation response includes EAS information that allows the WTRU to access the newly instantiated application.

The method may include receiving the selected EAS Internet Protocol (IP) address, URL or FQDN in the response.

The method may provide for each un-instantiated application corresponding to an un-instantiated EAS comprised in the EDN.

A WTRU may be configured to receive a message from a network device. The message may provide a list of one or more edge application servers associated with an un-instantiated application. The WTRU may select an EAS from the list of one or more EAS associated with the un-instantiated application. The WTRU may transmit a request to an EDN. The request may request to instantiate the un-instantiated application at the selected EAS. The WTRU may receive a response from the EDN. The response may indicate that the un-instantiated application has been instantiated at the selected EAS and/or indicate information for accessing the now instantiated application at the EAS.

The WTRU may be configured to transmit an EAS discovery request to the EDN. The EAS discovery request may indicate one or more EAS requirements. The WTRU may transmit a message which includes an EAS discovery response received in response to the EAS discovery request.

The WTRU may send a request to an EAS of the EDN.

The WTRU may transmit a message which includes a service provisioning message.

The WTRU may, wherein the information for accessing the now instantiated application indicates that the now instantiated application has been synchronously instantiated, and the edge application server instantiation response includes edge application server information associated with the selected edge application server.

The WTRU my include in its response an Internet Protocol (IP) address of the selected EAS.

A method implemented by a WTRU may include transmitting an application server discovery request to a data network. The application server discovery request may include indicating one or more application server requirements. The method may further provide for receiving an application server discovery request message from a network device. The message may be comprising a list of one or more application servers associated with an application that satisfy the one or more application server requirements. The application server discovery request may provide for indicating that the application is not currently instantiated at the one or more application servers. The method may provide for selecting an application server from the list of one or more application servers associated with the application. The method may include transmitting a request to the data network. The request may include indicating a request to instantiate the application at the selected application server. The method may include receiving a response from the data network. The response may include indicating that the application has been instantiated at the selected application server and indicating information for accessing the application at the application server.

The method may include comprising a list of one or more application servers associated with the application where the application is currently instantiated.

A WTRU may be configured to transmit an EAS discovery request to an edge data network. The EAS discovery request may indicate one or more EAS requirements. The EAS may receive an EAS discovery response message from EDN, the message comprising a list of one or more EAS that satisfy the one or more EAS requirements. The EAS discovery request may indicate that the EAS is not currently instantiated. The WTRU may select an EAS from the list of one or more EAS. The WTRU may transmit a request to the EDN. The request may indicate a request to instantiate the selected EAS. The WTRU may receive a response from the EDN. The response may indicate that the selected EAS has been instantiated and indicating information for accessing the selected application server.

A WTRU may be configured to receive an edge service provisioning procedure message from a network device. The edge service provisioning procedure message may include a list of one or more EAS that are not currently instantiated. The WTRU may select an EAS from the list of one or more EAS that are not currently instantiated. The WTRU transmit a request to an EDN. The request indicating a request to instantiate the selected EAS. The WTRU may receive a response from the EDN. The response may indicate that the selected EAS has been instantiated and/or indicating information for accessing the selected EAS.

The WTRU may send a request to and/or receive a response from an edge enabler server (EES) of the EDN.

The WTRU may provide a message which comprises a list of one or more already EAS.

The WTRU may include information for accessing the now instantiated EAS indicates whether the now EAS has been synchronously or asynchronously instantiated.

The WTRU may include information for accessing the now instantiated EAS. The information may indicate that the now instantiated EAS has been synchronously instantiated, and/or the service provisioning procedure message

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating an example SA6 architecture for enabling edge applications;

FIG. 3 is a diagram illustrating an example high level cloud service architecture;

FIG. 4 is a diagram illustrating an example machine learning based context aware rule learning framework;

FIG. 5 is a diagram illustrating an example high level overview for WTRU on-demand edge application server (EAS) instantiation;

FIG. 6 is a diagram illustrating an example procedure for WTRU on-demand EAS instantiation;

FIG. 7 is a diagram illustrating an example procedure for WTRU on-demand EAS selection;

FIG. 8 is a diagram illustrating an example procedure for WTRU on-demand EAS termination;

FIG. 9 is a diagram illustrating an example procedure for edge enabler server (EES) on-demand EAS instantiation;

FIG. 10 is a diagram illustrating an example WTRU-based edge autoscaling architecture;

FIG. 11 is a diagram illustrating an example WTRU-based edge autoscaling architecture in the edge enabler client (EEC); and

FIG. 12 is a diagram illustrating an example WTRU-based edge autoscaling architecture using network artificial intelligent (AI)/machine learning (ML).

### DETAILED DESCRIPTION

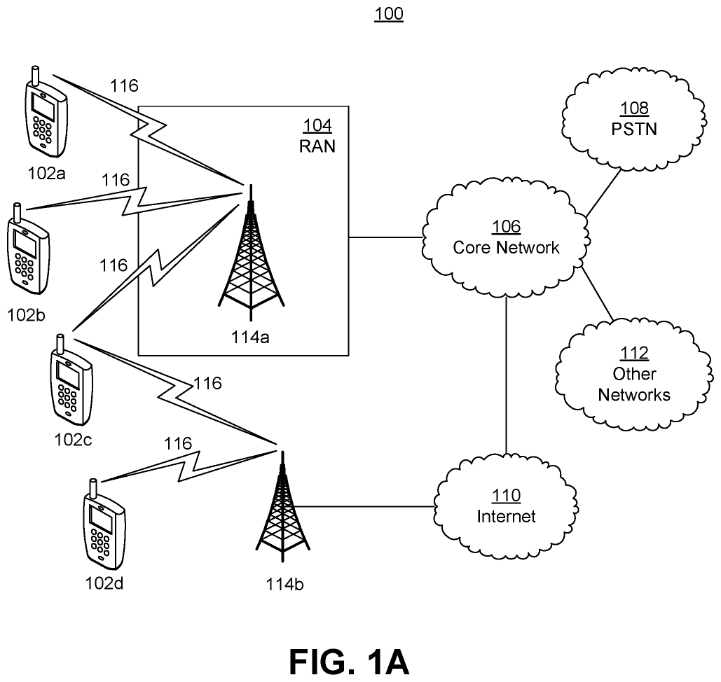

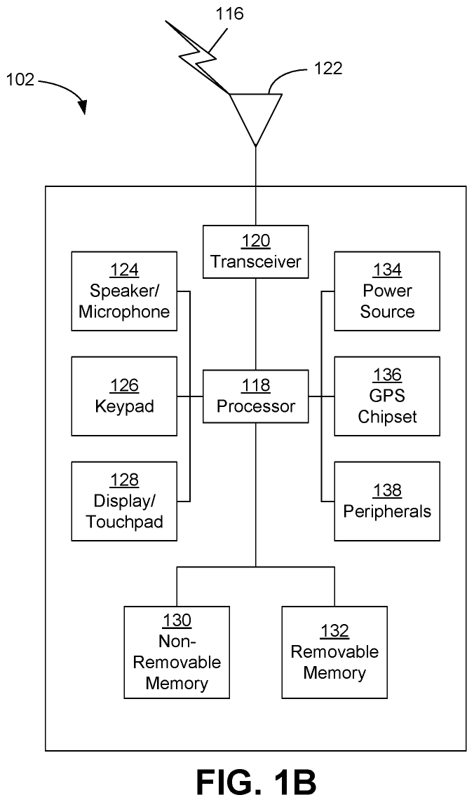

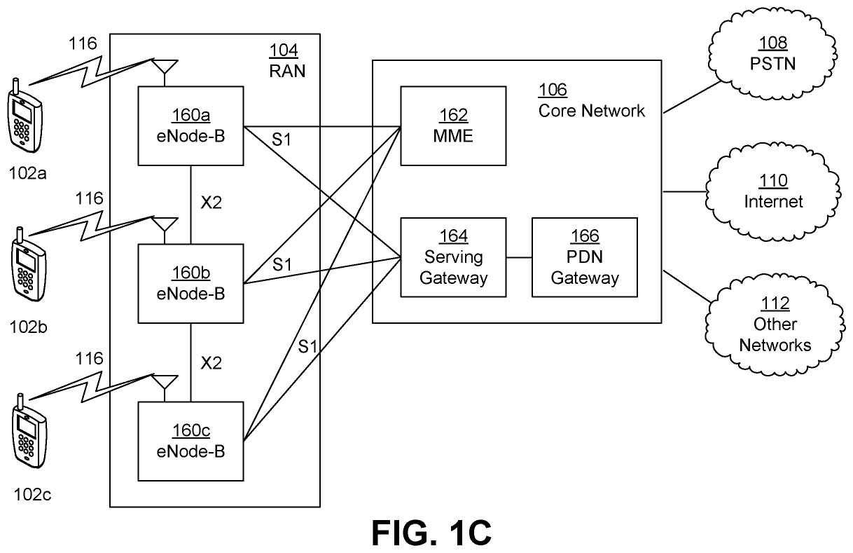

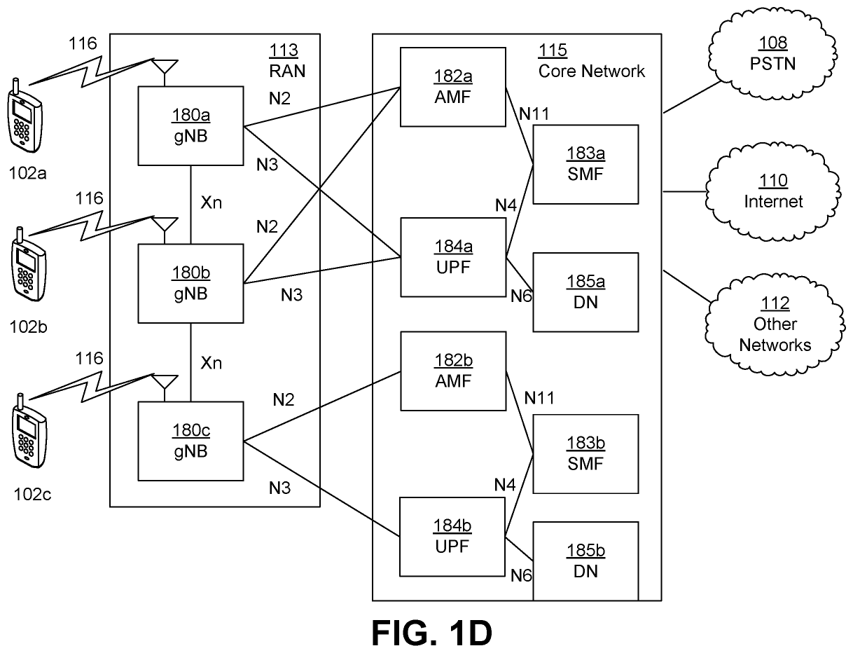

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A key feature of modern mobile networks is their capability to self-organize; Self-Organizing Network (SON) is a concept defined as automation technology designed to make planning, configuration, management, optimization, and healing of mobile radio access network simpler and faster. SON concepts may be applied to radio resources as terminals move in the network, and the network is constantly adjusting to terminal mobility to provide the best user experience.

SON concepts may also exist in cloud computing; a key aspect of cloud compute self-organization is called autoscaling. Autoscaling may be defined as dynamically adjusting the number of servers in a group, using the computational load of that group; the objective is to allow cloud applications to scale as usage increases. Cloud scaling techniques typically rely on key performance indicators (KPIs) measured at the servers and KPI provided by load balancers steering the incoming traffic to these servers. Autoscaling is coarse-grained and typically reactively applied to demand; this technique is well suited for datacenter environments where compute is co-located and abundant.

As edge computing becomes ubiquitous and compute moves close to mobile terminals, methods and apparatuses for scaling edge network resources are needed. Cloud computing autoscaling is not appropriate for handling edge fine-grained, limited, and distributed compute.

Mobile Edge Computing may require on-demand scaling involving the individual terminals context, which is opposite from mass cloud-based autoscaling.

In the same way SON became a core concept for radio network technology. Thus, it is expected that Self-Organizing Edge Compute (SOEC) becomes prevalent in future edge technology.

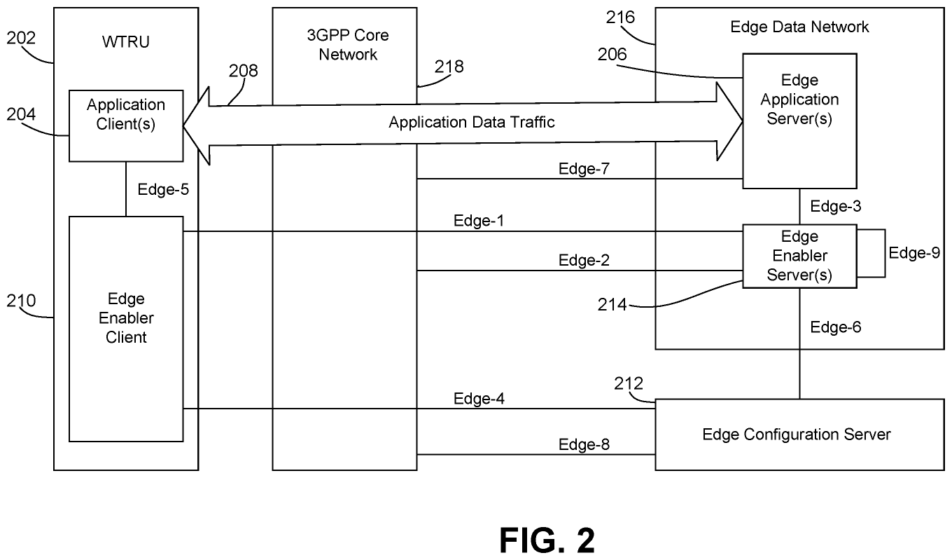

FIG. 2 is a diagram illustrating an example SA6 architecture for enabling edge applications. Examples for autoscaling and load-balancing are described herein. As described above, cloud-based autoscaling architecture is not appropriate when it is used in an edge-computing environment. Thus, WTRU-based edge autoscaling and its architecture are needed.

A WTRU 202 may include one or more application client(s) (AC) 204. The application client 204 may be a user application. The AC 204 may communicate with one or more edge application server (EAS) 206. The EAS 206 may be implemented as a standalone server or may be a software module implement on a general purpose server of the edge data network. The EAS may be implemented using any combination of hardware and software. Thus, if implemented as software on a general purpose server, the edge application server itself may be instantiated and/or un-instantiated on-demand. Similarly, applications running on the edge application server may be instantiated and/or un-instantiated on-demand. The WTRU 202 may use one or more ACs 204 concurrently. The information communicated between the AC 204 and EAS 206 may be application data traffic 208. The application data traffic 218 may be sent across the 3GPP core network 218. The EAS 206 and 3GPP core network 218 may communicate via the Edge-7 reference point.

One or more edge enabler client(s) (EEC) 210 may reside on the WTRU 202 with the ACs 204. The EEC 210 provides edge support to the AC 204 on the WTRU 202. While one or more ACs 204 and one or more EECs 210 may reside on the WTRU 202, one AC 204 may receive support from one EEC 210. The EEC 210 may communicate with the AC 204 via an Edge-5 node.

An edge configuration server (ECS) 212 may provide support functions needed for EECs 210 and/or edge enabler server (EES) 214. For example, the ECS 212 may discover one or more EESs 214, may provide edge configuration information to the EEC 210 and/or EES 214, and/or may register EESs 214. The network may include one or more ECS 212.

The EEC 210 and ECS 212 may communicate via an Edge-4 node. The ECS 212 and EES 214 may communicate via an Edge-6 node. The EES 214 and 3GPP core network 218 may communicate via the Edge-7 node. The ECS 212 and 3GPP core network 218 may communicate via the Edge-8 node.

The EES 214 may provide support functions needed for EASs 206 and EECs 210. For example, the EES 214 may provision EAS 206 configuration information to the EEC 210, may expose application context transfer events, may perform EEC 210 context transfers, may expose 3G)) core network and service capabilities to the EAS 206, and/or may register the EEC 210 and/or EES 214. When the WTRU 202 is mobile and/or relocating, the EES 214 may have separate functionality. For example, a source EES (S-EES) may be used before the WTRU 202 mobility/relocation happens. For example, a target EES (T-EES) may be used after the WTRU 202 mobility/relocation happens. A network may include one or more EES 214 per edge data network (EDN) 216.

The EES 214 and the EEC 210 may communicate via the Edge-1 node. The EES 214 and EAS 206 may communicate via an Edge-3 node. The EES 214 may communicate with another EES 214 in the EDN 216 via an Edge-9 node.

The EAS 206 may serve as a server resident in the EDN 216. In this capacity, the EAS 206 may act as the software which provides service to the AC 204. When the WTRU 202 is mobile and/or relocating, the EAS 206 may have separate functionality. For example, a source EAS (S-EAS) may be used before the WTRU 202 mobility/relocation happens. For example, a target EAS (T-EAS) may be used after the WTRU 202 mobility/relocation happens. A network may include one or more EAS 206 per edge data network (EDN) 216. Each EDN 216 may contain a different set of EASs 206. For example, some EASs 206 may serve a group of WTRUs 202 and/or ACs 204. For example, some EASs 206 may exclusively serve a single WTRU 202 and/or AC 204.

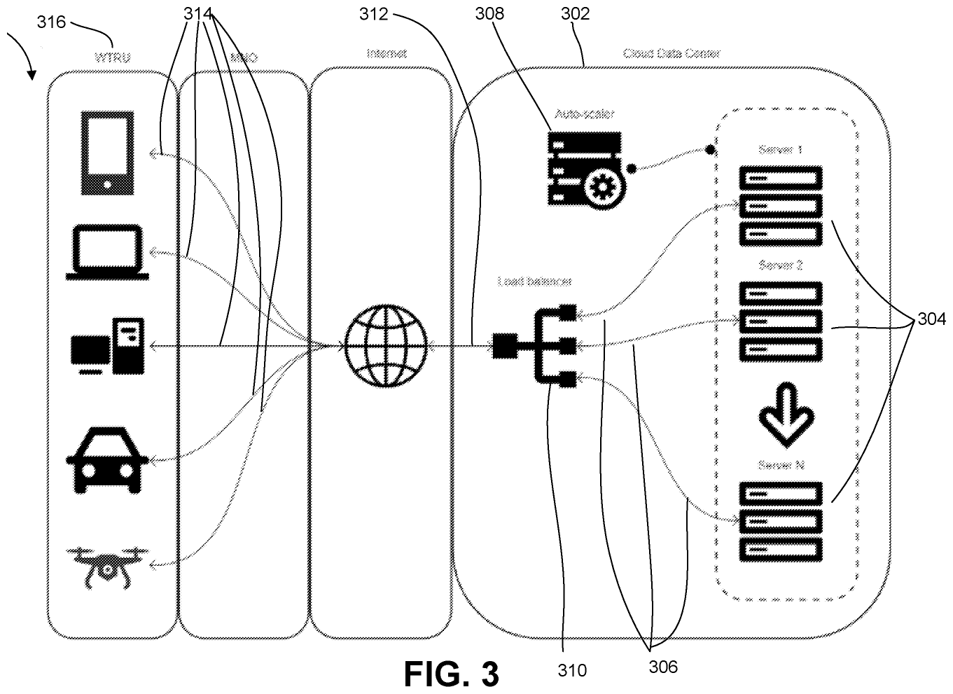

FIG. 3 illustrates an example high level cloud service architecture 300. FIG. 3 further depicts the cloud service architecture's ability to perform autoscaling.

Autoscaling may include, for example, a method to automatically change (e.g., scale up or down) the number of compute resources (e.g., servers) allocated for a cloud data center 302. For example, a cloud data center 302 may include one more servers 304.

Without autoscaling, a cloud data center wastes resources at idle time and may become unresponsive when treating too many incoming requests 306. Autoscaling may address the need for optimizing resource usage and supporting elastic compute that self-adjusts as demand grows. Autoscaling may be performed by an agent, e.g., auto-scaler 308. The auto-scaler 308 may collect KPIs and evaluate the KPIs if the amount of compute needs to be changed.

An auto-scaler 308 may use different types of KPIs. In examples, scheduled autoscaling may use time periods to augment/reduce capacity of a service. In examples, front-end traffic autoscaling may be used for scaling based on the number of incoming requests 306. One or more load-balancers 310 handle the front-end incoming traffic 312, including the KPIs, in front of the cloud servers 304. In examples, back-end scaling can be based on load (e.g., number of jobs in the queue) or on time (how long jobs have been queued). The cloud servers 304 obtain back-end traffic 314, including KPIs, on back-end scaling. Depending on implementation, the auto-scaler may rely on temporal, front-end KPIs and back-end KPIs to perform autoscaling decisions.

The role of a load-balancer 310 in a cloud system may include steering traffic originating at the WTRU 316 to an available server resource 304. The load-balancer 310 may steer traffic in a pre-determined way (e.g., round-robin). The load-balancer 310 may steer traffic in a dynamic way by considering the server-load KPIs to direct requests to the servers 304 that are less busy.

Together, the auto-scaler 308, the load-balancer 310 and KPI acquisition framework (e.g. front-end traffic 312 and back-end traffic 314) may comprise components of any cloud computing architectures found today. An example of cloud computing architectures may include context-aware rule learning from smartphone data as described herein. A WTRU 316-based edge autoscaling architecture that may use and/or interact with the context-awareness framework present on a WTRU 316 is described in this disclosure.

Recent developments and increase in WTRU 316 processing power have driven popularity and interest for context-aware technology. Data analytics and building data-driven context-aware systems may be used to build intelligent context-aware applications on WTRUs 316. This requires advanced data analytical techniques with high precision and intelligent decision-making strategies based on contexts. Machine learning based techniques may provide effective and efficient results for smartphone data analytics and corresponding context-aware rule learning.

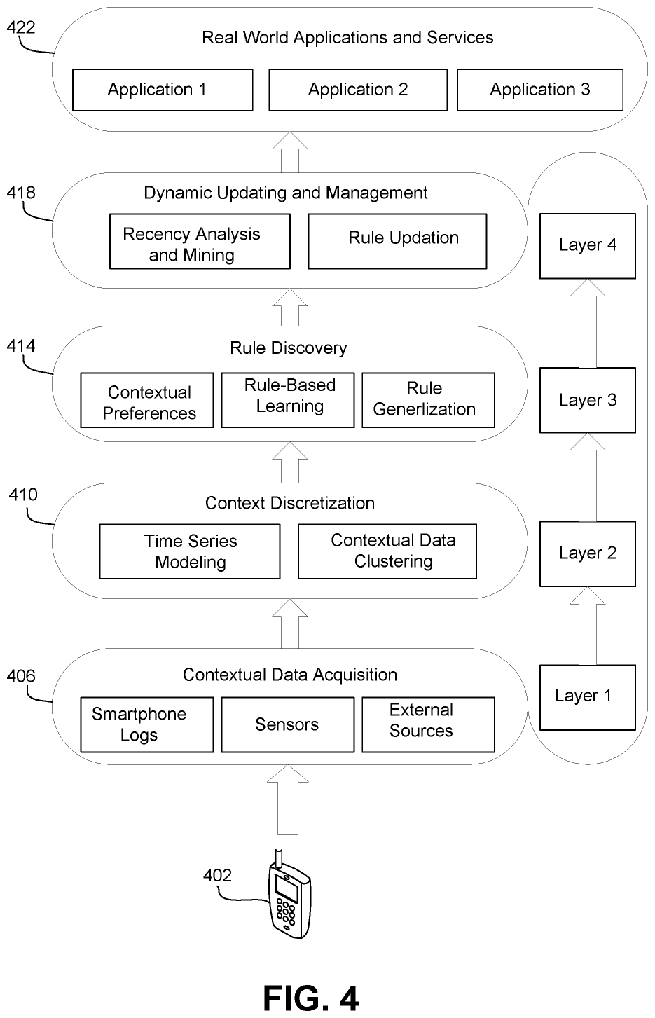

FIG. 4 illustrates an example machine learning based context aware rule learning framework. Specifically, FIG. 4 presents an exemplary machine learning (ML) framework for deriving context aware rules from WTRU raw data where raw data may be acquired from various sources and then manipulated using various techniques, e.g., ML and artificial intelligence techniques. These techniques then may derive contextual rules used to influence the WTRU's behavior.

For example, a learning technique may involve a WTRU 402 performing a series of steps, (e.g., layers) which involve the WTRU acquiring data, analyzing data, and learning rules from said data acquisition and analysis. For example, the first step, e.g. layer 1, involves the WTRU 402 participating in contextual data acquisition 406. Relevant data obtained via contextual data acquisition 404 may include, e.g., smartphone logs, sensors, and/or external sources. Then, at layer 2, i.e. context discretization 410, the WTRU 402 may analyze the acquired data through use of different techniques, e.g. time series modeling and/or contextual data clustering.

From analyzing this data, the WTRU 402 may then generate some rules during the rule discovery 414 phase at level 3. To discovery rules, the WTRU 402 may apply contextual preferences, rule-based learning technique, and/or rule generalization parameters.

When the WTRU 402 has applied the techniques described during rule discovery 414, the WTRU 402 may refine the learned rules at level 4, known as dynamic updating and management 418. In refining its learned rules the WTRU may apply recency analysis and mining techniques. The WTRU 402 may also perform rule updation to keep learned rules current with the acquired data and modeling techniques used at context discretization 410.

The WTRU 402 may apply the newly learned and defined rules when serving real world applications and services 422. At this stage, the WTRU may serve applications with the support of its newly learned and defined rules.

As described above, cloud autoscaling may not meet the characteristics required to realize a self-organizing edge compute (SOEC) architecture.

As described in FIG. 2, the 3GPP SA6 architecture has defined an edge enablement architecture which may provide means for terminals to discover and use edge application servers (EAS). This architecture couples EAS discovery with EAS instantiation causing a WTRU looking to perform discovery of available EAS (e.g., to select the best available option) to instantiate compute in an undesired manner. As described below, a WTRU that behaves this way contravenes fine-grained resource management principles required for edge-computing. In examples, coupling EAS discovery with EAS instantiation may cause unnecessary EAS instantiation and waste compute resources. A WTRU needs to discover possible EAS and/or request instantiation and use the EAS independently.

The current 3GPP SA6 architecture lacks the capability of terminating an EAS when an EAS is not required. This lack of capability causes resources to remain unused thereby contravening fine-grained resource management principles required for edge-computing. Unused EAS resources may remain unused, thereby wasting compute resources. A WTRU needs to indicate that it has ceased using edge compute resources.

Compute overprovisioning led to $26.6 billion in public cloud waste for 2021, up from $17.6 billion in 2020 and the trend is accelerating. This illustrates the coarseness of cloud autoscaling methods which will be disastrous if used in a distributed and resource limited edge environment. Thus, cloud-based autoscaling are coarse-grained and may not meet fine-grained autoscaling requirements of resource limited edge environment.

Examples of pertinent architecture include, e.g. enabling SOEC in 3GPP edge architecture, enabling WTRU-based edge compute management for 3GPP edge architecture, and/or enabling a fine-grained autoscaling in 3GPP edge architecture.

As described above, WTRU-based edge autoscaling may be needed to realize SOEC.

In examples, capabilities of the 3GPP edge enablement architecture needed to support a WTRU-based edge autoscaling architecture are described herein. These capabilities may include, e.g., Error! Reference source not found, Error! Reference source not found, Error! Reference source not found, and/or Error! Reference source not found.

Also described herein are examples of WTRU-based edge autoscaling architecture based on the 3GPP edge-enablement layer, WTRU-based auto scaling, and a WTRU method for on-demand EAS up-scaling.

On-demand EAS up-scaling may happen when a terminal (e.g., a network node, a network device, and/or a WTRU) attempts to discover an EAS to consume edge services. The procedure may comprise discovery of on-demand EASs not yet executing and requesting execution of an on-demand EAS.

In examples, edge compute nodes may have enough compute resources to over-provision EAS at the edge. When over-provisioning happens, more EAS than needed may be created and the required resources may remain unused and wasted until needed. Over-provisioning is common in cloud environments where resources are abundant. Compute elasticity may be realized using cloud autoscaling algorithms and/or procedures.

Typical edge computing environments are resource constrained and therefore optimized so only needed EAS are instantiated. A terminal needs to be able to discover un-instantiated EASs and trigger their instantiation when the terminal intends to use the resource and for the duration the terminal needs to use the resource.

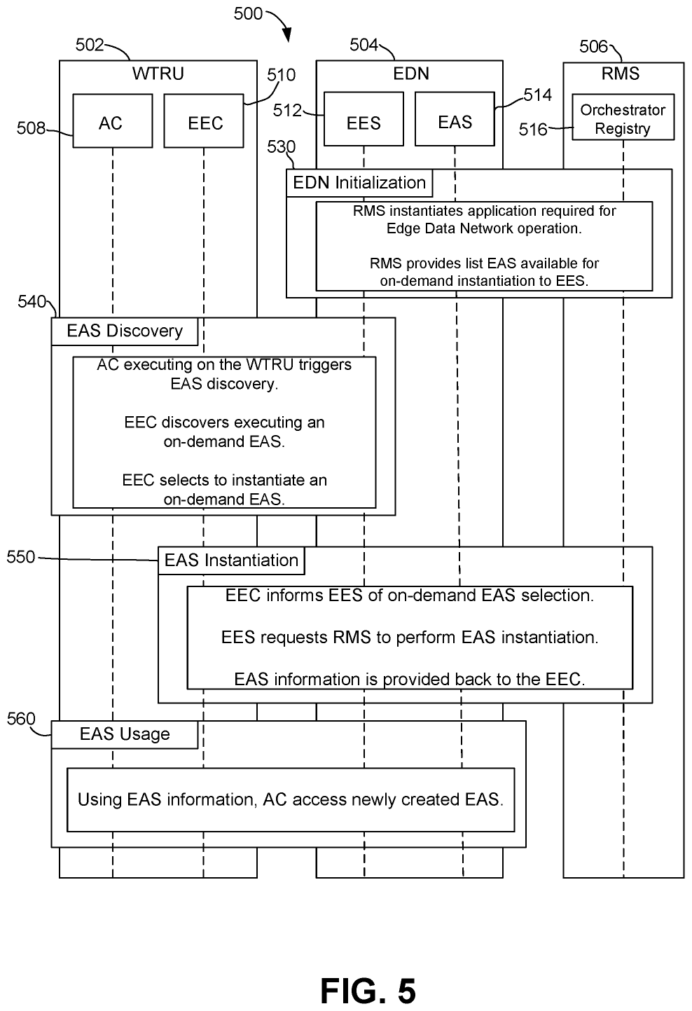

FIG. 5 illustrates an example high level overview for WTRU on-demand EAS instantiation 500. As illustrated in FIG. 5, network components comprising the EAS instantiation may include a WRTU 502, an EDN 504, and a Resource Management System (RMS) 506. The WTRU 502 may comprise an AC 508 and an EEC 510. The EDN 504 may comprise an EES 512 and an EAS 514. The RMS 506 may comprise an orchestrator and/or EAS registry 516 (e.g., the 3GPP Management System).

As illustrated in FIG. 5, the WTRU 502 on-demand edge EAS 514 instantiation may include four phases: EDN initialization, 530 EAS discovery 540, EAS instantiation 550, and EAS usage 560.

EDN initialization 530 may happen at EDN 504 creation and/or configuration time. During the EDN initialization 530, RMS 506 may create and initialize the edge enablement layer. RMS 506 may indicate to the newly created EES 512 which EAS 514 are available for WTRU 502 on-demand instantiation.

EAS discovery 540 may happen at EDN 504 runtime when an AC 508 needs to use an EAS 514. The AC 508 may trigger the EAS 514 discovery carried by the EEC 510. A WTRU 502 may discover EAS 514 instances available in EDN 504. The EEC 510 present on the WTRU 502 may discover executing an on-demand EAS 514.

EAS instantiation 550 may happen at EDN 504 runtime when the WTRU 502 decides to perform on-demand EAS instantiation 550. This may be performed by the EEC 510 present on the WTRU 502. The WTRU 502 may perform signaling with the edge enablement layer to trigger on-demand EAS instantiation 550. This may be performed by the EEC 510 present on the WTRU 502. The EES 512 may perform signaling with RMS 506 to perform on-demand EAS instantiation 550.

EAS usage 560 may happen at EDN 504 runtime, e.g., when the newly created EAS 514 becomes available to the WTRU 502. The WTRU 502 may access and use the newly created EAS 514. Access and usage may be performed by an AC 508 present on the WTRU 502.

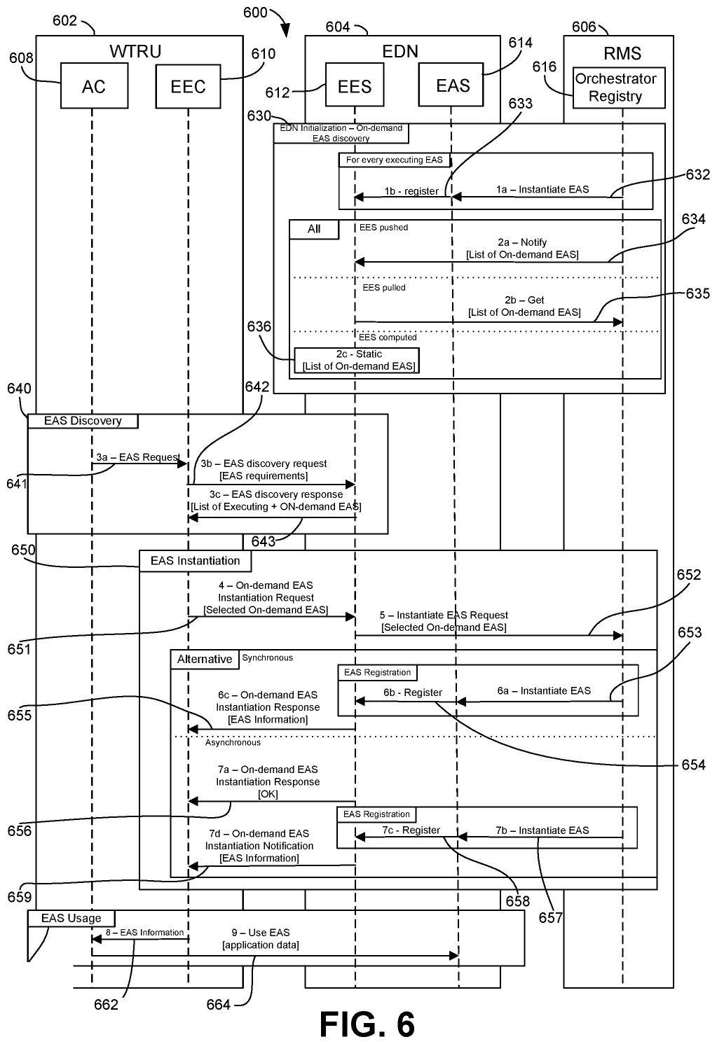

FIG. 6 illustrates an example procedure 600 for WTRU 602 on-demand EAS Instantiation. FIG. 6 presents details of the on-demand EAS instantiation procedure introduced in FIG. 5. FIG. 6 illustrates detailed messaging flow between the WTRU 602, EDN 604, and/or RMS 606 required for the WTRU 602 to perform the on-demand EAS instantiation needed for terminal-based edge-autoscaling.

The pre-conditions, condition, configuration, configured information by the network, pre-configuration, and/or pre-configured information to the WTRU 602 may include, e.g., the WTRU 602 having a valid subscription allowing for communication and usage of edge services present in the mobile network, the WTRU 602 being attached to the mobile network, the WTRU 602 having established a PDU session to the source EDN 604, and/or WTRU 602 being provisioned with security and authorization credentials necessary to communicate with elements composing the edge enablement layer (e.g., ECS, EES, etc.).

An example PDU session establishment procedure may be outlined in a 3GPP standard. The EDN 604 (a.k.a. DNN) selection may be typically provided by the PCF using URSP rules. The EDN 604 may also be provisioned via other methods (e.g., fixed, a user profile, EEC, etc.).

At EDN initialization 630, RMS 606 may have previously instantiated (not shown on FIG. 6) components of the edge enablement layer such as the EES 612. If the EDN 604 is configured for EAS 614 over-provisioning, one or more EAS 614 may be created by the RMS 606 associated with the EDN 604. As the EAS 614 start executing, the EAS 614 may register to its associated EES 612.

At step 1a at 632, the orchestrator and/or registry 616 may cause (not shown on FIG. 6) the EDN 604 to fetch an EAS image from the orchestrator registry 616. The EDN 604 may start execution of the fetched EAS 614 on a hardware platform present in the EDN 604. The EDN 604 configuration may trigger step 1a at 632, thereby instructing RMS 606 to instantiate a predefined EAS 614. Alternatively or additionally, the EES 612 may trigger step 1a at 632 by requesting over-provisioning of one or more EASs 614.

At step 1b at 633, upon startup, each EAS 614 may register to its EES 612. As a result, each registered EAS 614 may be discovered as an executing EAS. Each registered EAS 614 may provide service(s) to the WTRU 602.

At step 2, as part of the EDN initialization 630 procedure, and to support on-demand EAS instantiation from the WTRU 602, the EES 612 may learn of the EASs 614 available for on-demand instantiation.

In examples, step 2a at 634, may include a message providing the list of on-demand EASs 614. The RMS 606 may provide the list of on-demand EASs. The orchestrator and/or registry 616 may know the list. The RMS 606 and/or orchestrator and/or registry 616 may provide the EES 612 via an API call to the EES 612.

Alternatively or additionally, at 635, the EES 612 may access and inspect the RMS 606 to learn the list of on-demand EAS 614. An API call to the RMS 606 and/or orchestrator and/or registry 616 may discover the EAS 614 list.

Alternatively or additionally, at 636, the EES 612 may have a pre-configured on-demand EAS 614 list.

Although not shown in FIG. 6, if the EES 612 previously registered with the ECS, the EES 612 may update its registration with the ECS by providing the on-demand EAS 614 list.

In step 3, when a WTRU 602 needs to use an edge service, the WTRU 602 may request to perform EAS discovery 640. For example, an AC 608 executing on the WTRU 602 may request the EEC 610 to perform EAS 614 discovery.

In step 3a at 641, an AC 608 may inform the EEC 610 that it wants to use an EAS 614. This may be performed via different techniques. For example, the AC 608 can issue a DNS request that is intercepted by the EEC 610. Alternatively or additionally, the AC 608 may perform an API call to the EEC 610. Alternatively or additionally, the AC 608 may use a software library that ends up informing the EEC 610. Alternatively or additionally, the AC 608 may perform an OS call that will inform the EEC 610.

In step 3b at 642, an EEC 610 may issue an EAS discovery request towards an EES 612 containing AC 608 identifiers and EAS 614 selection filters. Upon reception of the request, the EES 612 may perform a lookup for EAS 614 that could fulfill the AC 608 requirements. The EES 612 may consider executing EAS 614 (e.g. registered EAS) and/or an on-demand EAS 614 (e.g. list of on-demand EAS) to fulfill EAS 612 lookup based on request parameters. Both executing and on-demand EAS 614 may be considered in the EAS 614 lookup based on request parameters.

Although not shown on FIG. 6, alternatively or additionally to issuing an EAS discovery 640 request, a WTRU 602 and/or an EEC 610 may subscribe for receiving EAS 614 discovery notifications. The subscription may include the AC 608 identifiers and/or EAS 614 selection filters.

Information included in an EAS discovery 640 request is defined in 3GPP 23.558 v17.1.0 clause 8.5.3.2. Information included in an EAS discovery 640 subscription is defined in 3GPP 23.558 v17.1.0 clause 8.5.3.4. Discovery filters defined in 3GPP 23.558 v17.1.0 table 8.5.3.2-2, may be further provided with additional information, e.g., EAS 614 category, and/or EAS 614 on-demand discovery filters. The contents of 3GPP 23.558 v17.1.0 are hereby incorporated by reference herein.

The EAS 614 category may indicate if the requester wants to be informed of executing EAS 614 (e.g. registered EAS) only, an on-demand EAS 614 (e.g., list of on-demand EAS) only, and/or both types. Alternatively or additionally, the EAS 614 status field may be extended for specifying EAS 614 category.

The EAS 614 on-demand discovery filters may include filter information indicating requested KPIs for on-demand instantiation. Alternatively or additionally, the EAS discovery 640 filters may be extended for specifying EAS 614 on-demand discovery filters. For example, average instantiation duration may be used to specify that average EAS instantiation 650 time does not take more than the indicated duration to instantiate the EAS 614. Instantaneous instantiation duration may be used to specify that EAS instantiation 650 time does not take more than the indicated duration to instantiate the EAS 614 in the current platform state. Instantiation failure rate may specify that average EAS instantiation 650 failure rate does not exceed the indicated failure rate when instantiated this EAS 614. Implicit on-demand instantiation using existing “AC Schedule” and “EAS Schedule” parameters may be used to provide a matching window that implicitly triggers the instantiation of one or more EAS 614 instances.

In step 3c at 643, EES 614 may return to the WTRU 602 a list of EAS 614 that may include executing (e.g. registered EAS) and/or on-demand (e.g., list of on-demand EAS) EAS 614. Alternatively or additionally (not shown on FIG. 6), the EES 612 may send an EAS 614 discovery notification to the WTRU 602 if using an EAS discovery 640 subscription.

The EAS discovery 640 response or notification may include a list of EAS 614 which should include necessary information required for EAS 614 selection and, subsequently, EAS 614 communication. The information provided for executing EAS 614 (e.g. registered EAS) is defined in 3GPP 23.558 v17.1.0, clause 8.5.3.3 if using request and 3GPP 23.558 v17.1.0, and clause 8.5.3.6 if using notifications. The EAS Profile is defined in 3GPP 23.558 v17.1.0, clause 8.2.4.

The EAS Profile, EAS discovery 640 response and EAS discovery 640 notifications are provided with information to support on-demand EAS 614, e.g., EAS Profile, EAS discovery 640 response, and/or EAS discovery 640 notification. EAS 614 profile may include, e.g., EAS 614 category and/or EAS 614 on-demand KPIs. Alternatively or additionally, the EAS category and/or EAS status may indicate if the EAS 614 is executing EAS (e.g., registered EAS) or on-demand (e.g., list of on-demand EAS). Alternatively or additionally, EAS 614 on-demand KPIs and/or EAS Service KPIs may indicate on-demand EAS KPIs for instantiation. These EAS Service KPIs may be the same as EAS 614 on-demand discovery filters defined in step 3b at 642. EAS discovery 640 response and/or EAS discovery 640 notification may include an existing lifetime parameter. The existing lifetime parameter may be set to “0” to indicate “on-demand” EAS 614.

In step 4 at 651, upon reception of the list of EAS 614 (as shown in step 3c at 643), the WTRU 602 may perform an EAS 614 selection. The EEC 612 may perform this selection. As illustrated in FIG. 6, the EEC 612 may select an on-demand EAS 614 from the received list. The EEC 612 may send an on-demand EAS instantiation request 651 to the EES 612 indicating the selected EAS 614.

On-demand EAS instantiation request 651 may be performed by invoking an API of the EES 612. Information in the request may include, e.g., requestor identifier, WTRU 602 identifier, security credentials, WTRU 602 location, requested service continuity (SC) support, requested SC planning, EAS 614 characteristics, and/or EAS 614 instantiation information.

The requestor identifier may be the ID of the requestor (EECID). The WTRU 602 identifier may be GPSI or an identity token. The security credentials may be resulting of successful authorization with edge-computing service. The WTRU 602 location may be described in 3GPP 23.558 v17.1.0 clause 7.3.2. The requested SC support may be application context relocation (ACR) type requested by the EEC 610. The requested SC planning may indicate whether the EES 612 performs SC planning for this application. EAS 614 characteristics may correspond to EAS 614 discovery filter described in 3GPP 23.558 v17.1.0 table 8.5.3.2-2 and further provided in step 3b at 642 of this procedure.

The EAS instantiation information may indicate whether to perform EAS instantiation 650 may be performed synchronously or asynchronously from the on-demand EAS instantiation request 651. The EAS notification endpoint is the endpoint exposed by the EEC 610 to receive EAS 614 information if using asynchronous EAS instantiation. An EAS instantiation 650 timeout may be duration allowed by the WTRU 602 to perform the instantiation. After this duration, the WTRU 602 may consider the instantiation to have failed and the instantiation needs to be cancelled.

In step 5 at 652, upon reception of the EAS instantiation request 651 from the WTRU 602, the EES 612 may send the EAS instantiation request 651 to the RMS 606. The request to RMS 606 may include, e.g., EAS 614 identifiers obtained in step 2 of this procedure and/or information received from the EAS instantiation request 651 from step 4. The request to RMS 606 optionally, alternatively, and/or additionally may indicate hardware resources where the EAS 614 needs to be instantiated.

In examples as seen in step 6, EAS instantiation 650 may be performed synchronously from the on-demand EAS instantiation request 651. The EES 614 may hold on to the on-demand EAS instantiation response at step 6c at 655 until the newly requested EAS 614 has been instantiated in the EDN 604 at step 6a at 653 and registered to the EES 612 at step 6b at 654. In this example model, details about the newly created EAS 614 may be included in the on-demand EAS instantiation response 655 at step 6c.

The data included in the EAS instantiation response 655 may be similar to the data of the EAS discovery response described in step 3 at 643. The EAS instantiation response 655 contains a result code for the EAS instantiation 650. If successful, the result code may describe the newly instantiated EAS 614 as an executing EAS (e.g. registered EAS).

In examples as seen in step 7, EAS instantiation 650 may be performed asynchronously from the on-demand EAS instantiation request 651, due to e.g., long instantiation time of certain applications. In step 7a at 656, the EES 612 may return a response immediately to the WTRU 602 indicating success or failure of the request. The EAS 614 may be created in the EDN 604 at step 7b at 657. The EAS 614 may have registered to the EES 612 at step 7c at 658. The EES 612 may issue a notification to WTRU 602 at step 7d at 659 indicating details of the newly created EAS 612 in the notification body. The WTRU 602 may need to subscribe with EES 612 to receive EAS 614 notification as a pre-requisite to use the asynchronous mode.

The information included in the EAS instantiation response 656 provides a status that the request of step 4 at 651 has been received. The information included in the EAS instantiation response 656 may further indicate if the request can be processed at this time. A failure may indicate that the request is not accepted, and a reason may be provided. The request may be re-submitted.

The information included in the EAS instantiation notification 659 may be similar to data of the EAS instantiation response 655 described in step 6. The EAS instantiation notification 659 may include a result code for the EAS instantiation 650. If successful, the result code may describe the newly instantiated EAS 614 as an executing EAS 614.

In step 8 at 662, EAS information may be relayed back to the requesting WTRU 602 depending on the method used for requesting EAS usage 660. For example, an AC 608 executing on the WTRU 602 may receive the EAS IP address in a DNS response. Alternatively and/or additionally, the AC 608 may receive the EAS IP address in an API response issued for example from the EEC 610. Alternatively or additionally, it can receive the EAS IP address from a function call return value. Alternatively and/or additionally, it may receive the EAS IP address in an OS call response.

In step 9 at 664, the WTRU 602 may access the on-demand EAS 614 using the received IP address. An AC 608 executing on the WTRU 602 may acquire this access.

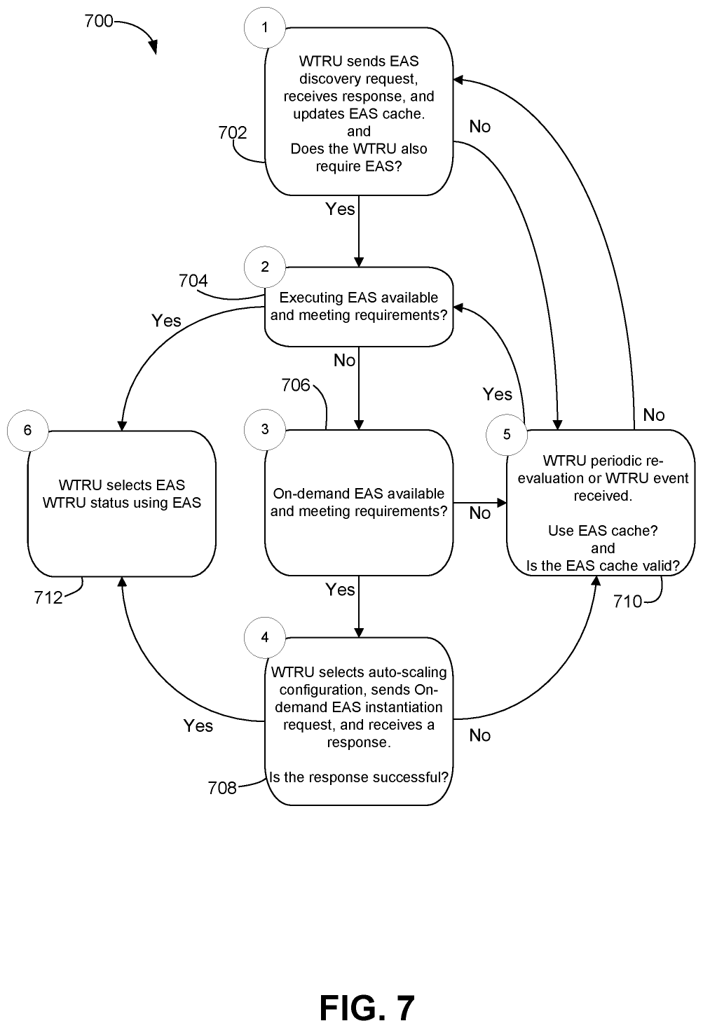

FIG. 7 presents an exemplary selection procedure 700 that may be performed on a WTRU, e.g. by an EEC. The exemplary selection procedure 700 shows how a EAS discovery response can be evaluated when combining both executing (e.g. registered EAS) and on-demand (e.g. list of on-demand EAS) EAS. The exemplary selection procedure 700 shows how an on-demand EAS can be selected for WTRU-based edge autoscaling. The exemplary selection procedure 700 shows fallback paths if EAS selection fails.

FIG. 7 illustrates an example procedure for WTRU on-demand EAS selection. For example, FIG. 7 may present a WTRU exemplary selection method that could be performed by an EEC.

In step 1 at 702, the WTRU may send an EAS discovery request and receive an EAS discovery response. Alternatively or additionally, if the WTRU subscribed for EAS discovery, the WTRU may receive an EAS discovery notification. Upon receiving the EAS discovery information, the WTRU may update its internal EAS cache. These actions may be performed for example by an EEC on the WTRU. These actions may be triggered as described in step 3 of FIG. 6 (e.g., specifically at step 3b at 642 and step 3c at 643 and/or because of a periodic update). If an AC executing on the WTRU requires to use an EAS, the WTRU may proceed to step 2 at 704.

In step 2 at 704, the WTRU first may verify if any executing EAS (e.g. registered EAS) meets the AC requirements. If an executing EAS is found and meets requirements, the WTRU may select the EAS and proceed to step 6 at 712. If the WTRU does not find an executing EAS (e.g. registered EAS), the WTRU may proceed to step 3 at 706. These actions may be performed, for example, by an EEC executing on the WTRU.

In step 3 at 706, the WTRU may choose to instantiate an on-demand EAS since no executing EAS was found and/or meeting requirements. If an on-demand EAS is found and meets the requirements, the WTRU may select the EAS and attempt to instantiate the EAS in step 4 at 708. If no EAS meets requirements, the WTRU may attempt re-evaluation in step 5 at 710. These actions may be performed for example by an EEC executing on the WTRU.

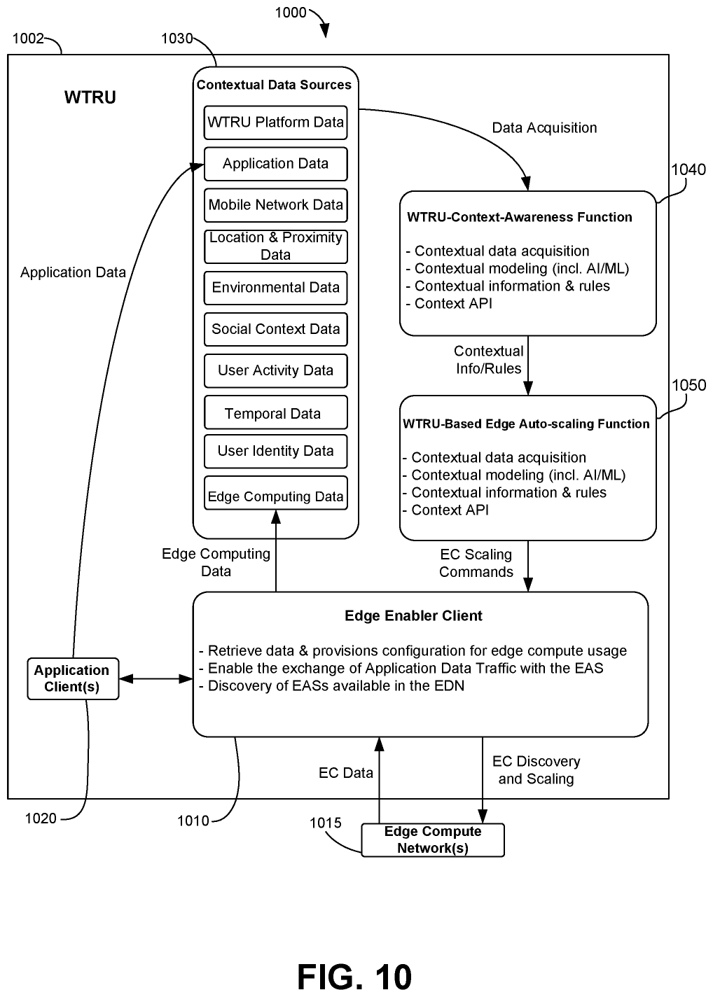

In step 4 at 708, the WTRU may attempt to instantiate the selected EAS by forming an EAS instantiation request as described in step 4 of FIG. 6 at 651. Contextual WTRU information such as application usage, platform state, and/or the connectivity conditions may influence the request content. More details on WTRU conditions are described in FIG. 10.

The WTRU may send the on-demand EAS instantiation request and receive the response. If the response is successful, the WTRU may select the provided EAS and may inform AC in step 6 at 712. If the instantiation failed, the WTRU may attempt re-evaluation in step 5 at 710. An EEC executing on the WTRU may perform these actions.

In step 5 at 710, the WTRU in this state may be dormant. The WTRU may periodically (e.g., on a time period) decide to re-evaluate its current condition. Alternatively or additionally, the WTRU may receive waking events, e.g. from an AC executing on the WTRU to request for EAS, from a cache validity expiration timer, and/or from a network event such as an ECS notification and/or EES notification.

The WTRU may decide to resolve the request by using its EAS discovery cache if appropriate, the WTRU may proceed to perform re-evaluation using the cache in step 2 at 704. Alternatively or additionally, if the WTRU cache is invalid or the WTRU determines that the cache needs to be refreshed, it may proceed to step 1 at 702 to query the network and perform EAS discovery again. An EEC executing on the WTRU may perform these actions.

In step 6 at 712, the WTRU may select an EAS and start using the selected EAS as described in step 8 and 9 of FIG. 6 at 662 and 664, respectively. Selection may be performed by an EEC and usage by an AC, both executing on the WTRU.

The 3GPP architecture for enabling edge computing does not support EAS termination from a WTRU. Rather, WTRU method for on-demand EAS down-scaling is needed. Embodiments for WTRU method for on-demand EAS down-scaling may occur when a WTRU does not need to use an on-demand EAS. The procedure may comprise termination of on-demand EAS that may have been previously instantiated by a WTRU. Pre-conditions and/or configurations described in FIG. 6 may apply, with the addition that the WTRU may use one or more on-demand EASs.

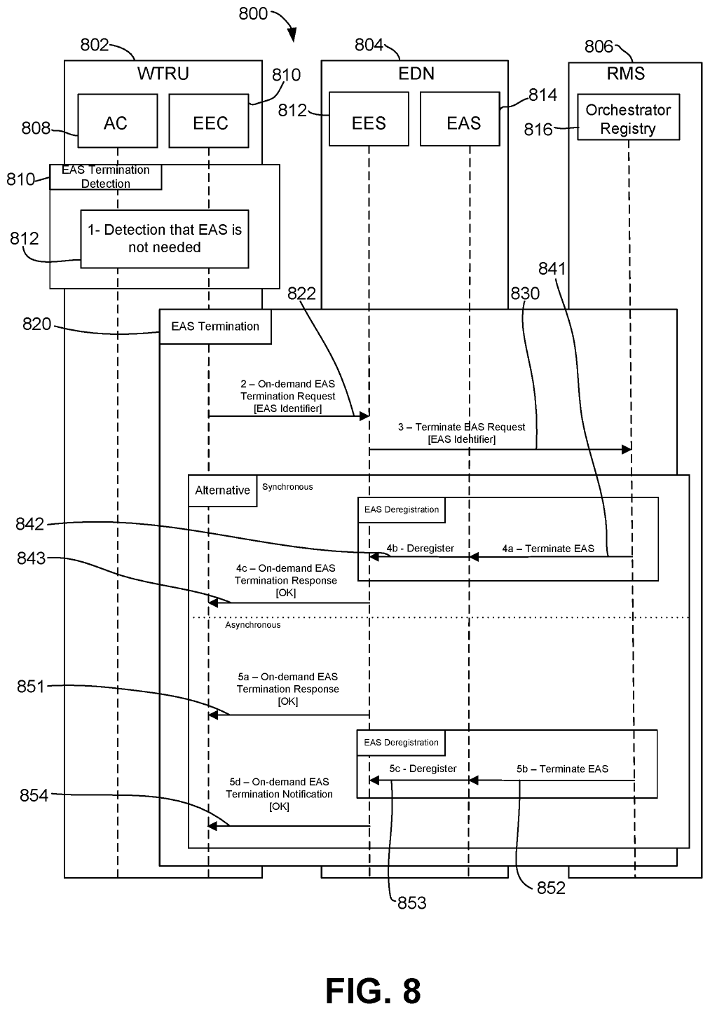

FIG. 8 illustrates an example procedure 800 for WTRU 802 on-demand EAS termination 810. In step 1 at 812, a WTRU 802 may periodically (on a time basis) perform runtime verification of an EAS 814 that the WTRU 802 uses. The WTRU 802 may decide to terminate some EAS 814 to minimize its edge consumption footprint. Alternatively or additionally, the WTRU 802 may be informed that an EAS 814 is not required anymore and proceed with termination. The EEC 810 may perform the EAS 814 termination.

A WTRU 802 may choose to terminate an EAS 814 that the WTRU 802 has instantiated on-demand. Alternatively and/or additionally, a WTRU 802 may choose to terminate an executing EAS 814 that the WTRU 802 has discovered. A WTRU 802 may issue a termination request at any time and for any EAS 814 that the WTRU 802 previously discovered or instantiated.

Detection and notification of unused an EAS 814 may be performed via different techniques. For example, a WTRU 802 may detect that an AC 808 no longer runs via the WTRU 802 OS and the WTRU 802 may then terminate its associated EAS 814. Alternatively or additionally, an AC 808 can inform the EEC 810 via an API call that the EAS 814 is not required. Alternatively or additionally, a WTRU 802 may perform traffic detection to detect that an EAS 814 has not been used for some period. Other methods achieving similar results are possible.

The network may perform EAS termination at 820. In step 2 at 822, the WTRU 802 may issue an EAS termination request 822 towards the EES 812 associated with the EAS 814 indicating the EAS identifier for which termination is requested. The EEC 810 may make the request.

In step 3 at 830, upon reception of EAS termination request from the WTRU 802, the EES 812 may send an EAS termination request 822 to the RMS 806. The request to RMS 806 may include EAS identifiers received from the EAS termination request 822 from step 2 of this procedure.

The EAS termination request 822 may include one or more values indicating if immediate termination or delayed termination is requested. In case of delayed termination, the termination may be carried after a timer expires.

The EAS termination request 822 may indicate if the termination needs to be graceful or forced. A graceful termination may require the EES 812 to validate that no other active user is currently using the EAS 814. A forced termination may require the EES 812 to perform termination regardless of EAS 814 usage. WTRUs 802 may need authorization to terminate an EAS 814. For example, a WTRU 802 may not be allowed to force termination of EAS 814.

In the example of graceful termination, the EES 812 may validate with an EAS 814 if the EAS 814 can be terminated and/or still has active users. The EES 812 may learn usage by performing an API call to the EAS 814. Alternatively or additionally, the EES 812 may learn usage by keeping track of EAS 814 usage by WTRU 802 instances. In examples where usage prevents graceful termination, the EES 812 may choose actions to allow graceful termination. For example, the EES 812 may trigger ACR for the remaining users and graceful termination of the EAS 814 once EAS 814 user contexts have been relocated. If graceful termination cannot be executed, the EES 812 may choose to retry EAS 814 termination later or may choose not to perform the EAS 814 termination at all.

In the example of forced termination, the EES 812 may not validate EAS 814 usage and may terminate the EAS 814 immediately. Alternatively or additionally, the EES 812 may follow the graceful termination logic with the exception that ultimately the EAS 814 is terminated.

In step 4, in examples, EAS termination 820 may be performed synchronously from the on-demand EAS termination request 822. The EES 812 therefore may hold on to the on-demand EAS termination response 843 at step 4c. The EES 812 may hold on until the EAS termination 820 completes at step 4a and has deregistered from the EES 812 at step 4b as seen at 841 and 842, respectively.

The data included in the EAS termination response 843 may be status information on the termination request 822. For example, the response 843 may indicate that an EAS 814 has been terminated, that the termination has not been authorized, that the termination has been delayed, and/or that the termination had been rejected. The WTRU 802 may use the termination response to update its internal EAS 814 cache. An EEC 812 running on the WTRU 802 may use the termination response to update its internal EAS 814 cache.

In step 5, in examples, EAS termination 820 may be performed asynchronously from the on-demand EAS termination request 822, e.g., due to the long termination time of certain applications. The EES 812 therefore may return a response immediately to the WTRU 802 as in step 5a at 851. The response may indicate success or failure of the request. For example, the request may indicate that the termination 820 has not been authorized.

In case of successful termination, the EAS 814 is terminated at step 5b at 853 and has deregistered from the EES at step 5c. Indications of the EAS terminating and deregistering are seen at 852 and 853, respectively. The EES may issue a notification to the EEC 810 at step 5d at 854 indicating the status of EAS termination 820. In the example of failed termination, the notification may indicate that the termination has been delayed and/or rejected.

The WTRU 802 may subscribe to EAS notification as a pre-requisite to use the asynchronous mode. The data included in the EAS termination notification may be status information on the termination request.

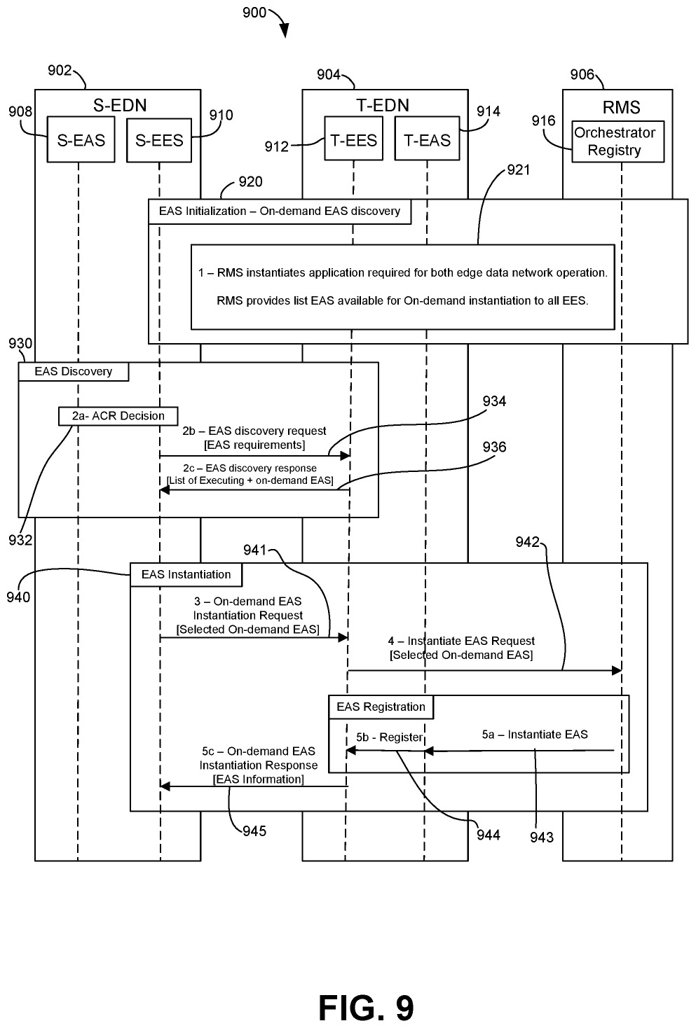

FIG. 9 illustrates an example procedure 900 EES on-demand EAS instantiation. As depicted in FIG. 9, the WTRU may have discovered and used a S-EAS 908 located in the S-EDN 902. All S-EES 910 and T-EES 912 may have the authorization to perform the described procedures.

Examples for EES method for on-demand EAS up-scaling on another EES may include a 3GPP edge enablement layer. The 3GPP edge enablement layer defines ACR procedures which may require a source EES (S-EES) 910 to request instantiation of EAS resources on a target EES (T-EES) 912.

These procedures are related to service continuity defined in defined in 3GPP 23.558 v17.1.0 clause 8.8. ACR may require instantiation of a target EAS (T-EAS) 914 located in a target location according to a WTRU movement. Service continuity planning (SCP) may require instantiation of several possible T-EAS located in one or more target locations according to a WTRU predicted future movement.

Certain ACR procedures may rely on the EEC executing on a WTRU to discover and instantiate the T-EAS 914 as reflected in 3GPP 23.558 v17.1.0 clause 8.8.2.2, clause 8.8.2.3, and clause 8.8.2.6. These procedures may benefit from the methods previously introduced in FIGS. 5-8.

Certain ACR procedures may require the EES (source or target) to perform the T-EAS 914 discovery as reflected in 3GPP 23.558 v17.1.0 clause 8.8.2.4, and clause 8.8.2.5.

In examples, although conceptually to WTRU on-demand EAS instantiation, EAS up-scaling requested by another EES may happen between two EDNs, the source EDN (S-EDN) 902 and target EDN (T-EDN) 904. The up-scaling procedure has several pre-conditions, conditions, configuration, or pre-configuration, e.g. a WTRU may have a valid subscription allowing for communication and usage of edge services present in the mobile network. The WTRU may be attached to the mobile network. The WTRU may have established a PDU session to the S-EDN 902. An example PDU session establishment procedure is outlined in 3GPP 23.502 v17.2.1 clause 4.3.2.2.1. EDN (a.k.a. DNN) selection is typically provided by the PCF using URSP rules. An example PDU session may also be provisioned via other methods (e.g., fixed, a user profile, EEC, etc.). The contents of 3GPP 23.502 v17.2.1 are hereby incorporated by reference herein.

In step 1 at 921, EDN initialization procedure 920 may be similar to the procedures described above. Both EDNs, e.g. the S-EDN 902 and T-EDN 904 may be provisioned with the edge enablement layer applications. The RMS 906 may provide each EES, e.g. the S-EES 910 and T-EES 912 with a list of on-demand EASs. The RMS 606 may instantiate the applications needed for edge data network operation.

In step 2, an EAS or EES may decide to perform ACR for a given WTRU. The S-EES 910 may attempt EAS discovery 930 a T-EAS 914 per 3GPP 23.558 v17.1.0 clause 8.8.3.2.

In step 2a, the S-EAS 908 may inform the S-EES 910 of ACR decision 932. Alternatively and/or additionally, S-EES 910 may decide that ACR is required.

In step 2b, the S-EES 910 may issue an EAS discovery request 934 towards an T-EES 912 indicating EAS requirements initially provided by the WTRU. Upon reception of the request, the T-EES 912 may perform a lookup for EAS that could fulfill the requirements. Both executing EAS (e.g. registered EAS) and on-demand EAS (e.g. list of on-demand EAS) may be considered in the EAS lookup based on request parameters. Information included in the EAS discovery request 934 may be the same as previously described in FIG. 6.

In step 2c, the T-EES 912 may return a response 936 to the S-EES 910 a list of EAS that may include executing (e.g. registered EAS) and on-demand (e.g. list of on-demand EAS) EAS. Information included in EAS discovery response 936 may be the same as previously described in FIG. 6.

In step 3, upon reception of the EAS discovery response 936, the S-EES 910 may perform an EAS selection. As illustrated in FIG. 9, the S-EES 910 may select an on-demand EAS from the received list. The S-EES 910 may send an on-demand EAS instantiation request 941 to the T-EES 912 indicating the selected EAS.

In examples, the EAS instantiation 940 begins with an on-demand EAS instantiation request 941 which may be performed by invoking an API of the T-EES 912. Information provided by the EAS instantiation request 941 may be the same as described in FIG. 6.

In step 4 at 942, upon reception of the EAS instantiation request 941 from the S-EES 910, the T-EES 912 may send an EAS instantiation request 942 to the RMS 906. The request to RMS 906 may include EAS identifiers obtained in step 1 at 921, information received from the EAS instantiation request 941 from step 3, and/or may optionally indicate hardware resource where the EAS should be instantiated.

In step 5, EAS instantiation 940 may be performed synchronously when used for ACR procedures. The T-EES 912 may therefore hold on to the on-demand EAS instantiation response 945 at step 5c until the newly requested T-EAS 914 has been created at step 5a at 943 and the T-EAS 914 may have registered to the T-EES 912 at step 5b at 944. Details about the newly created T-EAS 914 may be included in the on-demand EAS instantiation response 945 at step 5c at 945. The data included in the EAS instantiation response 945 may be the same as described in FIG. 6.

Examples of ECS methods for supporting of on-demand EAS provisioning are described herein. For example, during service provisioning procedures defined in 3GPP 23.558 v17.1.0 clause 8.3.3, a WTRU's EEC may attempt to discover, via an ECS, a list of EES suitable for providing services required by the WTRU's AC. As such, the ECS service provisioning response may include a list of EES which in turn includes a list of registered EAS identifiers corresponding to executing EAS.

To support on-demand EAS instantiation, the ECS service provisioning request may indicate the WTRU's EEC if executing EAS, on-demand EAS or both categories needs to be considered by the ECS when establishing the list of EES. The ECS service provisioning response may include a list of available on-demand EAS identifiers provided by the EES. On-demand EAS identifiers may be mixed with executing EAS identifiers in which case, the response format may remain the same and the list of EAS identifiers may contain both executing and on-demand EAS identifiers. Alternatively or additionally, the response format may contain an indication allowing the WTRU to distinguish between executing and on-demand EAS. For example the list of on-demand EAS identifiers may be a separate list which allows the WTRU to distinguish between executing and on-demand EAS available at the EES.

The list of on-demand EAS may be obtained by the ECS at EES registration or EES registration updates as defined in 3GPP 23.558 v17.1.0 clause 8.4.4. More specifically, when registering to the ECS, an EES issues a registration request which include an EES profile per 3GPP 23.558 v17.1.0 clause 8.4.4.3.2. The EES profile may include a list of EASIDs which could include both the executing and on-demand EAS. Alternatively or additionally, the executing and on-demand EAS identifiers may be differentiated, e.g., using separate lists. When an EES profile changes, the EES may issue EES registration update per 3GPP 23.558 v17.1.0 clause 8.4.4.3.4 which may include executing and on-demand EAS identifiers request which may also be differentiated.

During ACR procedures, it is possible that a S-EES performs T-EES discovery using the ECS. The ECS may then return a list of EES profiles back to the S-EES that may include on-demand EAS identifiers as previously described for the WTRU.

Examples for WTRU-based edge autoscaling architecture are describe herein. For example, FIG. 10 is a diagram illustrating an example WTRU-based edge autoscaling architecture 1000. This architecture 1000 may comprise various components described below, e.g. an edge enabler client (EEC) 1010 present on a WTRU 1002.

The EEC 1010 may be the WTRU 1002 edge enabler function providing access to edge compute network 1015 resources. The EEC 1010's functions may comprise retrieving edge compute data from the network 1015, maintaining an EEC 1010 configuration according to the retrieved edge computing (EC) data, providing discovery capabilities of EC resources, and/or providing access to EC resources.

Alternatively and/or additionally, as described above, the EEC 1010 may act as a gateway towards the EDN to provide on-demand up-scaling and down-scaling capabilities. Alternatively and/or additionally, the EEC 1010 may act as an edge compute data source for deriving a WTRU 1002 edge computing context. Information such as, e.g., available EDNs, available EES, available EAS, EAS usage by the WTRU 1002, and/or EAS KPIs retrieved from the network may be used to establish a WTRU 1002 edge computing context. The EEC 1010 may use different methods to provide an EC context on the WTRU 1002. For example, the information may be exposed via an EEC API, stored in files, provided via a shared database, obtained via the WTRU OS, and/or exposed via a library package.

The application client(s) (AC) 1020 may be the applications that require usage of EC. ACs 1020 may interface with the EEC 1010 via the EDGE-5 reference point to discover the endpoint address of EAS available in the network. The AC 1020 may also act as a contextual data source for deriving a WTRU 1002 context. Information such as, e.g., application configuration, application logs, and/or application notifications are examples of AC 1020 information that may be used to establish a WTRU 1002 application context.

Contextual data sources 1030 may be the different sources of data used to establish a WTRU 1002 context. In examples, such data may be used as a source to understand a user's behavioral activity patterns in different contexts. Alternatively and/or additionally to the contextual data sources 1030 described, EC data may be used for establishing a WTRU 1002 edge context and behavior. The data source can be obtained from a variety of sources such as, e.g., sensors, logs, hardware, OS, etc.

The WTRU-context-awareness function 1040 may use the contextual data source 1030 to derive context-aware rules that are used to adapt the behavior of a WTRU 1002 in different contexts. As an example, a WTRU 1002 may implement context aware user notifications. These notifications may be muted if the user is sleeping, attending a meeting, at work, and/or driving, etc. The use of Artificial Intelligence (AI) and Machine Learning (ML) techniques may be common in this type of contextual awareness function. In WTRU-based edge autoscaling, a contextual awareness function may produce the contextual data and rules used to make edge autoscaling decisions. The WTRU-context-awareness function 1040 may be implemented as a standalone application, may be part of a context awareness framework, may be part of an OS, may be provided by hardware components on the WTRU 1002, may be implemented as a function provided by an EEC 1010, and/or the WTRU-based edge autoscaling function 1050, etc.

WTRU-based edge autoscaling function 1050 may use contextual information produced by the WTRU context-awareness function 1040 to make decisions about up-scaling or down-scaling edge compute resources. Alternatively and/or additionally, the WTRU-based edge autoscaling function 1050 may use the raw contextual data directly. The WTRU-based edge autoscaling function 1050 may be implemented as a standalone application, may be part of an edge autoscaling framework, may be part of an OS, may be provided by hardware components on the WTRU 1002, and/or may be implemented as a function provided by the EEC 1010, etc.

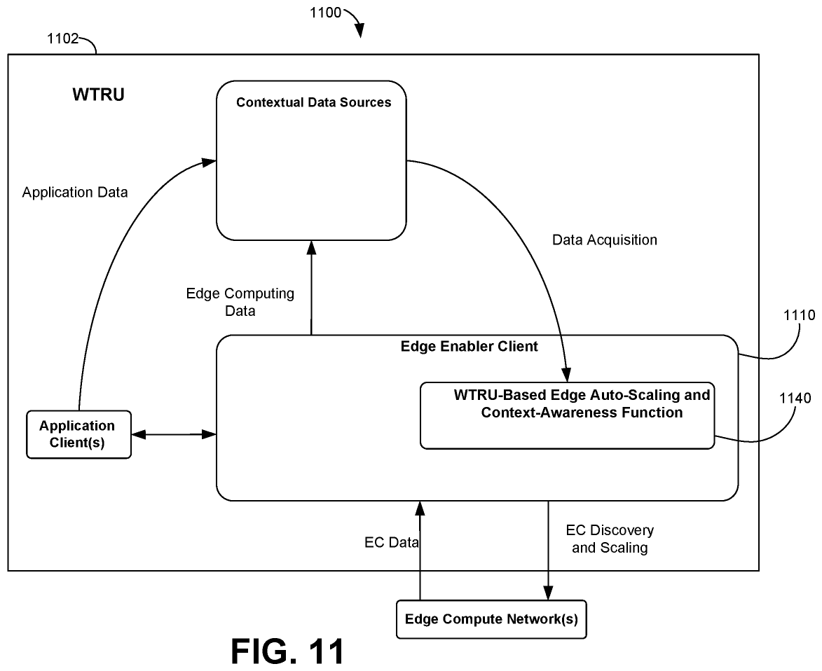

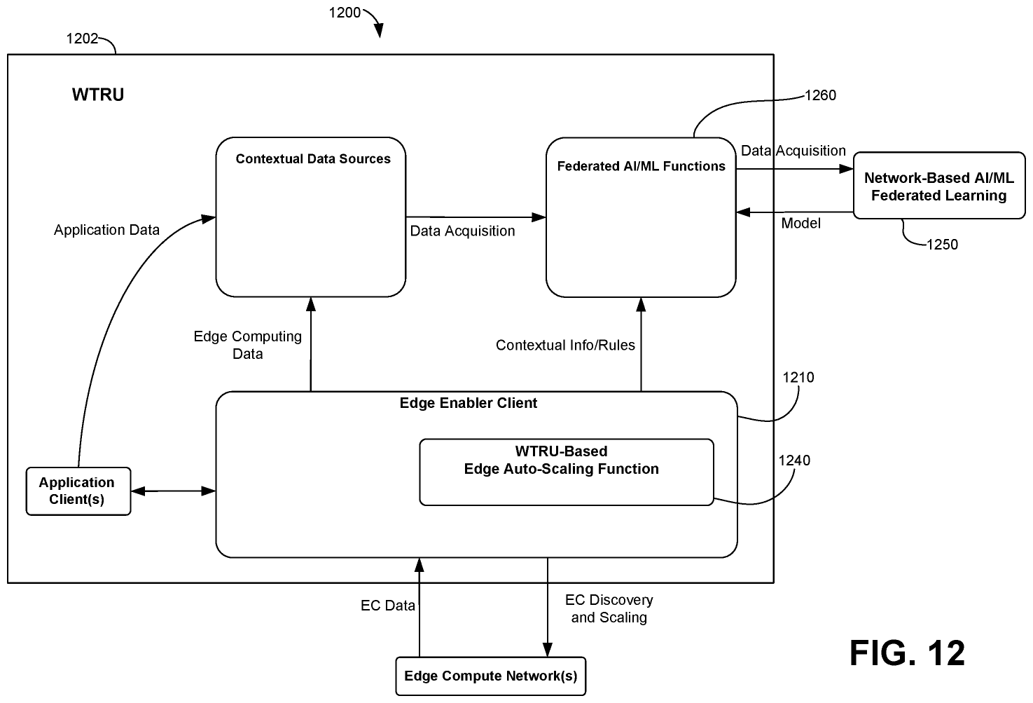

FIG. 11 and FIG. 12 are exemplary variations of the WTRU-based autoscaling architecture 1000 illustrated in FIG. 10.

FIG. 11 illustrates an example WTRU-based edge autoscaling architecture 1100 in the EEC 1110. FIG. 11 represents a compact variation of the WTRU 1102 elements where autoscaling and context awareness may be both implemented as part of an EEC 1110. Raw contextual data may be acquired by the EEC 1110 which can directly derive context rules and autoscaling decisions internally. Specifically, the WTRU-based edge auto-scaling an context-awareness function 1140 situated within the EEC 1110 may provide the context rules and autoscaling decisions to the EEC 1110.

FIG. 12 illustrates an example WTRU-based edge autoscaling architecture 1200 using network AI and/or ML. FIG. 12 is a variation where contextual awareness may be delegated to the network side. Raw contextual data collected at the WTRU 1202 may be sent to a network-based AI/ML Federated Learning function 1250, for example, via a federated learning function 1260 present on the WTRU 1202. The federated learning function 1260 may derive an advanced model by combining internal WTRU 1202 data with external data sources obtained from, e.g., other WTRUs, the network, the radio access network, and/or edge compute framework, etc. This model may then be used to derive rules employed by the WTRU-based edge autoscaling function 1240.

In examples, an autonomous drone may be used for infrastructure inspection operations and may require an edge service to perform real-time video analysis. The edge compute requirements of the video analysis service may be high (e.g., high-compute, GPU, substantial RAM and/or high bandwidth). The edge compute requirements may have high usage cost. Due to these constraints, the user may only provision a video analysis service for the time of inspection. An example of a WTRU-context-awareness information and/or rule may indicate that the drone (e.g., WTRU 1202) is in flight, has reached the inspection, has its camera activated, and/or is ready to send a video feed towards the edge-service. In response, the WTRU-based edge auto-scaling function 1240 may request instantiation of the edge-service when contextual requirements are met by requesting the EEC 1210 to perform EAS instantiation as described in FIG. 6.

In examples, several drones (e.g., multiple WTRUs 1202) may join to perform inspection in a coordinated manner. The joining drones (e.g., multiple WTRUs 1202) may initially share a single video analysis edge-service. In such case, the joining drones (e.g., multiple WTRUs 1202) may perform regular EAS discovery. The joining drones may discover the existing video analysis service. As more drones join, the video analysis service may become saturated. As more drones join, the video analysis service may not meet performance requirements, and discovery mat not return to the executing EAS. The WTRU-based edge autoscaling function 1240 on a newly joining drone may trigger the up-scaling of the service as described in FIG. 6 to increase edge video analysis capabilities.

As drones terminate their inspection and return to their home base, they may stop using the video analysis service. Each drone may send a graceful EAS termination request as described in FIG. 8. The EES may choose to terminate the EAS if no more drone is using it, or, alternatively and/or additionally, maintain the EAS.

As inspection completes, a drone may leave the area to return to its home base. The WTRU-based edge auto-scaling function 1240 may be made aware that inspection has terminated (e.g., camera off). Upon learning that inspection has terminated, the WTRU-based edge auto-scaling function 1240 for that drone may send a graceful EAS termination request as described in FIG. 8. The EES may choose to downscale the video analysis service if no more drone is using it; alternatively or additionally maintain the service or perform ACR to another instance of the service followed by service termination. Once the last drone completes inspection, WTRU-based edge auto-scaling function 1240 may send a graceful EAS termination request causing termination of the edge video analysis service.

In examples, an autonomous vehicle (e.g., WTRU 1202) may use edge-services for performing computations assisting in collision avoidance. As the vehicle moves, sensor data may be sent to the edge and combined with other vehicle information. In this example, each vehicle has its own edge service and data may be shared between edge services. Assuming the vehicle is parked, the collision avoidance service may no longer be required. The WTRU-context-awareness function may provide information that the user is driving or parked, and the WTRU-based edge autoscaling function 1240 can down-scale the driving assistance edge-service until the driver starts moving again.

In examples, a game on a WTRU 1202 may require a gaming-edge-service instance for each individual player. When played collaboratively, a second edge-service acting as the session rendezvous point may be needed for each collaborative session. As the first player starts playing (e.g. player 1), the WTRU-based edge auto-scaling function 1240 may up-scale the gaming-edge-service instance. As a second player arrives (e.g. player 2), the WTRU-based edge autoscaling function 1240 may up-scale the gaming-edge-service instance and instantiate the rendezvous-edge-service as it is not yet available. As a third player joins (e.g., player 3), the WTRU-based edge autoscaling function 1240 may choose to only instantiate the gaming-edge-service as the rendezvous-point-service already exists.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1-21. (canceled)

22. A method implemented by a wireless transmit/receive unit (WTRU), the method comprising:
transmitting an edge application server (EAS) discovery request to an edge data network (EDN), wherein the EAS discovery request comprises one or more EAS requirements;
receiving an EAS discovery response from the EDN, the EAS discovery response including a list of one or more EASs associated with an un-instantiated application that meets the one or more EAS requirements;
selecting an EAS from the list of one or more EASs;
transmitting an EAS instantiation request to the EDN, the EAS instantiation request indicating the selected EAS; and
receiving an EAS instantiation response from the EDN, the EAS instantiation response indicating that the selected EAS has been instantiated at the EDN, wherein the EAS instantiation response comprises instantiation information associated with the selected EAS.

23. The method of claim 22, wherein the instantiation information indicates whether the selected EAS has been synchronously instantiated or asynchronously instantiated.

24. The method of claim 23, wherein the instantiation information indicates that the selected EAS has been synchronously instantiated, and the EAS instantiation response comprises EAS information associated with the selected EAS.

25. The method of claim 22, wherein the EAS instantiation response comprises an Internet Protocol (IP) address, fully qualified domain name (FQDN), or uniform resource locator (URL) of the selected EAS.

26. The method of claim 25, wherein an application client (AC) residing on the WTRU accesses the selected EAS based on the IP address.

27. The method of claim 22 further comprising:
selecting, by an edge enabler client (EEC) residing on the WTRU, the EAS from the list of one or more EASs.

28. The method of claim 22, wherein the EAS discovery request comprises one or more application client (AC) identifiers and EAS selection filters.

29. The method of claim 22, wherein the EAS instantiation request comprises one or more of requester identifier, WTRU identifier, security credentials, WTRU location, requested service continuity (SC) support, requested SC planning, EAS characteristics, or EAS instantiation information.

30. The method of claim 22, wherein the EAS receives the instantiation response from the EDN via a domain name system (DNS) response, an application programming interface (API) response, a function call return value, or an operating system (OS) call response.

31. The method of claim 22, wherein the EAS discovery request comprises one or more of application usage, WTRU platform state, or connectivity conditions.

32. A wireless transmit/receive unit (WTRU) comprising a processor and a memory, the processor configured to:
transmit an edge application server (EAS) discovery request to an edge data network (EDN), wherein the EAS discovery request comprises one or more EAS requirements;
receive an EAS discovery response from the EDN, the EAS discovery response including a list of one or more EASs associated with an un-instantiated application that meets the one or more EAS requirements;
select an EAS from the list of one or more EASs;
transmit an EAS instantiation request to the EDN, the EAS instantiation request indicating the selected EAS; and
receive an EAS instantiation response from the EDN, the EAS instantiation response indicating that the selected EAS has been instantiated at the EDN, wherein the EAS instantiation response comprises instantiation information associated with the selected EAS.

33. The WTRU of claim 32, wherein the instantiation information indicates whether the selected EAS has been synchronously instantiated or asynchronously instantiated.

34. The WTRU of claim 33, wherein the instantiation information indicates that the selected EAS has been synchronously instantiated, and the EAS instantiation response comprises EAS information associated with the selected EAS.

35. The WTRU of claim 32, wherein the EAS instantiation response comprises an Internet Protocol (IP) address, fully qualified domain name (FQDN), or uniform resource locator (URL) of the selected EAS.

36. The WTRU of claim 35, wherein an application client (AC) residing on the WTRU accesses the selected EAS based on the IP address.

37. The WTRU of claim 32, the processor further configured to:
select, by an edge enabler client (EEC) residing on the WTRU, the EAS from the list of one or more EASs.

38. The WTRU of claim 32, wherein the EAS discovery request comprises one or more application client (AC) identifiers and EAS selection filters.

39. The WTRU of claim 32, wherein the EAS instantiation request comprises one or more of requester identifier, WTRU identifier, security credentials, WTRU location, requested service continuity (SC) support, requested SC planning, EAS characteristics, or EAS instantiation information.

40. The WTRU of claim 32, wherein the EAS receives the instantiation response from the EDN via a domain name system (DNS) response, an application programming interface (API) response, a function call return value, or an operating system (OS) call response.

41. The WTRU of claim 32, wherein the EAS discovery request comprises one or more of application usage, WTRU platform state, or connectivity conditions.
